(19) United States
(12) Patent Application Publication
(10) Pub. No.: US 2014/0299098 A1
(43) Pub. Date: Oct. 9, 2014

(54) METHOD FOR OPERATING AN INTERNAL COMBUSTION ENGINE

(71) Applicant: Andreas Stihl AG & Co., KG, Waiblingen (DE)

(72) Inventors: Michael Raffenberg, Fellbach (DE); Clemens Klatt, Winnenden (DE)

(73) Assignee: Andreas Stihl AG & Co. KG, Waiblingen (DE)

(21) Appl. No.: 14/245,649

(22) Filed: Apr. 4, 2014

(30) Foreign Application Priority Data
Apr. 4, 2013 (DE) 10 2013 005 807.4

(51) Int. Cl. F02P 5/145

(52) U.S. Cl. CPC F02P 5/145
USPC 123/406.12

(57) ABSTRACT

An internal combustion engine includes a cylinder and a piston journalled to reciprocate therein. The cylinder and piston conjointly delimit a combustion chamber into which a spark plug projects. Ignition of the spark plug occurs at an ignition time point controlled by a control unit. The ignition time point is controlled in an idle speed range according to an idle control having a most advanced ignition time point. The engine has a decompression valve which, when open, connects the combustion chamber to a pressure relief space. The valve is open during engine start and closes when pressure in the combustion chamber exceeds a closing pressure. To close the valve, the ignition occurs in the idle speed range for an engine cycle departing from the idle control at a closing ignition time point lying approximately 5° crankshaft angle ahead of the most advanced ignition time point.

### CROSS REFERENCE TO RELATED APPLICATION

This application claims priority of German patent application no. 10 2013 005 807.4, filed Apr. 4, 2013, the entire content of which is incorporated herein by reference.

### BACKGROUND OF THE INVENTION

DE 195 04 105 A1 discloses an internal combustion engine which has a decompression device. The known decompression device is triggered automatically during the actuation of a pull-rope starter and in the process the decompression valve is opened. The decompression valve closes on account of the combustion pressure which is produced in the cylinder during a combustion.

The ignition of internal combustion engines is usually controlled by a control device. In an idling speed range, the ignition takes place at a comparatively retarded ignition time point. During idling, it is intended to be achieved that the rotational speed does not increase excessively, which results in a constant idling speed and only low rotational speed fluctuations during idling. It has been shown, however, that, in known decompression valves, the combustion pressure which prevails on account of the late ignition time point is not always reliably sufficient to close the decompression valve. In order to ensure that the decompression valve is closed reliably by the combustion pressure during idling, narrow tolerances have to be maintained on the decompression valve, which tolerances lead to a more complicated manufacture of the decompression valve.

### SUMMARY OF THE INVENTION

It is an object of the invention to provide a method for operating an internal combustion engine, by way of which method even a decompression valve of simple construction can be closed reliably.

In order to achieve reliable closing of the decompression valve, it is provided that, for at least one engine cycle, the ignition takes place at a closing ignition time point which lies approximately 5° of crankshaft angle before the most advanced ignition time point, in particular lies at least approximately 5° of crankshaft angle before the most advanced ignition time point. Here, the most advanced ignition time point is the most advanced ignition time point which is provided according to the idle control of the ignition time point. Accordingly, the ignition is adjusted in the direction of “advance” in the idle speed range for at least one engine cycle. Here, an adjustment in the advanced direction of the ignition time point for a single engine cycle can be sufficient. However, it can also be provided to adjust the ignition time point in the direction of “advance” for a plurality of engine cycles, in particular for a plurality of engine cycles which follow one another, in order to ensure that at least one sufficiently pronounced combustion takes place which leads to reliable closing of the decompression valve. The idle control can provide a comparatively retarded ignition time point which ensures that smooth running of the engine in the idle speed range results and which reliably prevents backward thrust of the engine, that is, driving of the engine in the opposite rotational direction. The ignition time point which is provided according to the idle control does not have to be adapted to the closing pressure of the decompression valve. A more pronounced combustion takes place in the combustion chamber in the at least one engine cycle, in which the ignition takes place at the closing ignition time point. As a result, a higher pressure is achieved in the combustion chamber, which higher pressure leads to reliable closing of the decompression valve. An excessively complicated construction of the decompression valve or excessively accurate production of the decompression valve is not necessary as a result.

The method according to the invention can be used in every type of internal combustion engine having a decompression valve, for example in a conventional internal combustion engine having a mechanical carburetor, in an internal combustion engine having a fuel quantity which is to be metered in electronically, or an engine of the like. In particular, the method according to the invention is used in two-stroke engines having a pull-rope starter or electric starter.

The closing ignition time point advantageously lies before the most advanced ignition time point by at most approximately 40° of crankshaft angle. As a result, backward thrust of the engine can still be avoided reliably. The closing ignition time point advantageously lies before the most advanced ignition time point by at least approximately 10° of crankshaft angle, in particular approximately 20° of crankshaft angle. As a result, a sufficiently high combustion pressure is achieved in the combustion chamber, with the result that the decompression valve closes reliably. The ignition time point is advantageously defined using the idle control to from 0° to approximately 20° of crankshaft angle before top dead center, and the closing ignition time point lies from approximately 25° to approximately 50° of crankshaft angle before top dead center.

The at least one engine cycle, in which the ignition takes place at the closing ignition time point, advantageously takes place during the first 100 engine cycles, in particular during the first 50 engine cycles after the starting operation. Here, the starting operation means the actuating operation of the internal combustion engine until the first combustion takes place in the combustion chamber. After the first combustion, the internal combustion engine is operated at idling, until an acceleration from the idling speed range takes place.

In order to ensure that a pronounced combustion takes place in the at least one engine cycle, in which the ignition takes place at the closing ignition time point, it is advantageously provided that at least one engine cycle precedes this engine cycle, during which at least one engine cycle no ignition takes place. In particular, a plurality of engine cycles without ignition precede the at least one engine cycle, at which the ignition takes place at the closing ignition time point. The internal combustion engine is advantageously ignited at the closing ignition time point until a combustion has taken place in the combustion chamber. This ensures that the decompression valve is closed. To this end, it is provided that a determination is carried out as to whether a combustion has taken place in the combustion chamber after an engine cycle, in which the ignition has taken place at the closing ignition time point. If no combustion has been detected, it is provided that the ignition in the next engine cycle again takes place at the closing ignition time point. The determination as to whether a combustion has taken place can be carried out in a simple way by virtue of the fact that the rotational speed of the crankshaft is monitored. If the rotational speed increases to a more pronounced extent during the downward stroke of the piston, that is, the acceleration exceeds a limit value, a combustion has taken place. However, it can also be provided to perform the determination as to whether a combustion has taken place via a pressure sensor in the combustion chamber. It can also be provided to monitor whether the decompression valve is closed and to perform the ignition at the closing ignition time point until the decompression valve has closed.

The closing ignition time point can be a fixed ignition time point which is stored in the control device. However, it can also be provided that the closing ignition time point is determined starting from an ignition time point which is provided according to the idle control. For example, the ignition time point, which is provided according to the idle control, can be adjusted in the direction of “advance” by a number of degrees of crankshaft angle which is stipulated in the control unit. Here, the ignition time point which is provided according to the idler controller can be the ignition time point for the following engine cycle or an ignition time point of the preceding engine cycle. The control unit can make provision to interrupt the idle control in the engine cycle or engine cycles, in which the ignition takes place at the closing ignition time point. However, the control unit according to the idle control can also be overridden or the ignition time point which is provided can be shifted to a more advanced ignition time point.

The idle control advantageously controls the ignition time point depending on the rotational speed of the internal combustion engine. It is provided here, in particular, that the ignition time point is adjusted in the direction of “retard” in the case of an increasing rotational speed. As a result, smooth running of the internal combustion engine during idling with low rotational speed fluctuations is achieved. However, it can also be provided that the idle control fixes the ignition time point to a constant ignition time point. The decompression valve opens into a pressure relief space. The pressure relief space is, in particular, the surroundings or the interior of a crankcase of the internal combustion engine.

### BRIEF DESCRIPTION OF THE DRAWINGS

The invention will now be described with reference to the drawings wherein:

FIG. 1 shows a side view of a cutoff machine;

FIG. 2 is a schematic of the construction of the drive of the cutoff machine from FIG. 1;

FIG. 3 is a section view through the internal combustion engine of the cutoff machine from FIG. 1;

FIG. 4 is a diagram which specifies the ignition time point as a function of the rotational speed;

FIG. 5 shows a diagram which specifies the maximum pressure in the combustion chamber and the ignition time point for the first 50 engine cycles;

FIG. 6 is a diagram which specifies the profile of the combustion chamber pressure and the ignition time point for the 29th engine cycle from FIG. 5;

FIG. 7 shows a diagram which specifies the profile of the combustion chamber pressure and the ignition time point for the 30th engine cycle of the diagram from FIG. 5;

FIG. 8 is a section view through a decompression valve;

FIG. 9 is a diagram which specifies the maximum pressure in the combustion chamber and the ignition time point for the first 50 engine cycles for a further embodiment; and,

FIG. 10 is a flow diagram showing the sequence of the method.

### DESCRIPTION OF THE PREFERRED EMBODIMENTS OF THE INVENTION

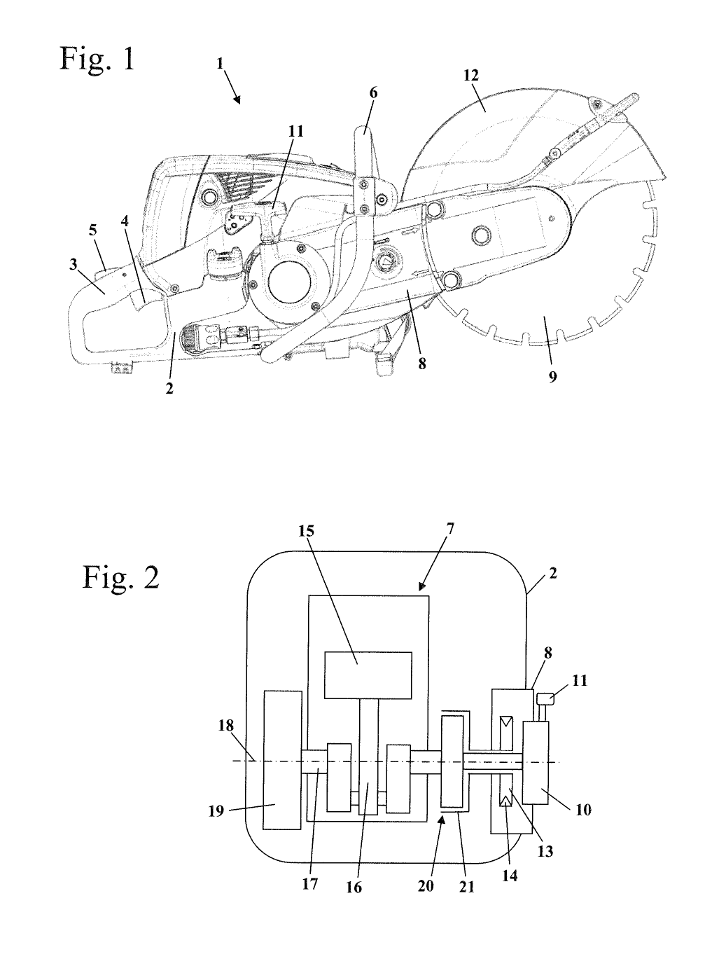

FIG. 1 shows a cutoff machine 1 as an embodiment for a portable, hand-held work implement. The method, which is described in yet greater detail in the following text for operating an internal combustion engine, can also be used in internal combustion engines for other fields of use, in particular in internal combustion engines in other work implements, such as power saws, brushcutters, blowers, spray units, harvesting machines, lawnmowers or the like. The cutoff machine 1 has a housing 2, on which two handles are fixed for guiding the cutoff machine 1 during operation, namely, a rear handle 3 and a bale handle 6. A throttle lever 4 and a throttle lever lock 5 are mounted pivotably on the rear handle 3. An arm 8 protrudes to the front on that end of the housing 2 which lies facing away from the rear handle 3. A cutting disc 9 is mounted rotatably on the free end of the arm 8. The cutting disc 9 is covered over part of its circumference by a protective hood 12. An internal combustion engine 7, which is shown in FIG. 2, is arranged in the housing 2. The cutting disc 9 is driven rotationally by the internal combustion engine 7. A pull-rope starter 10 (shown diagrammatically in FIG. 2), which has a pull-rope handle 11, serves to start the internal combustion engine 7. As FIG. 1 shows, the pull-rope handle 11 protrudes out of the housing 2 of the cutoff machine 1.

The internal combustion engine 7, which is shown schematically in FIG. 2, is advantageously a single cylinder engine, in particular an oil-in-fuel engine, preferably a two-stroke engine. The internal combustion engine 7 has a piston 15 which drives the crankshaft 17 via a connecting rod 16 so as to rotate about a rotational axis 18. A flywheel 19 is fixed on the crankshaft 17. The flywheel 19 can be configured as a fan wheel and can have fan vanes for delivering cooling air for the internal combustion engine 7. A centrifugal clutch 20 is fixed on the crankshaft 17 on that side of the internal combustion engine 7 which lies facing away from the flywheel. The centrifugal clutch 20 has centrifugal weights (not shown) which are connected fixedly to the crankshaft 17 so as to rotate therewith and interact with a clutch drum 21. The clutch drum 21 is connected fixedly to a drive pulley 13 so as to rotate therewith, on which drive pulley 13 a drive belt 14 is arranged. The drive belt 14 runs in the arm 8 and drives the cutting disc 9. As FIG. 2 shows, the pull-rope starter 10 is arranged on the arm 8 adjacent the drive pulley 13 and acts on the crankshaft 16.

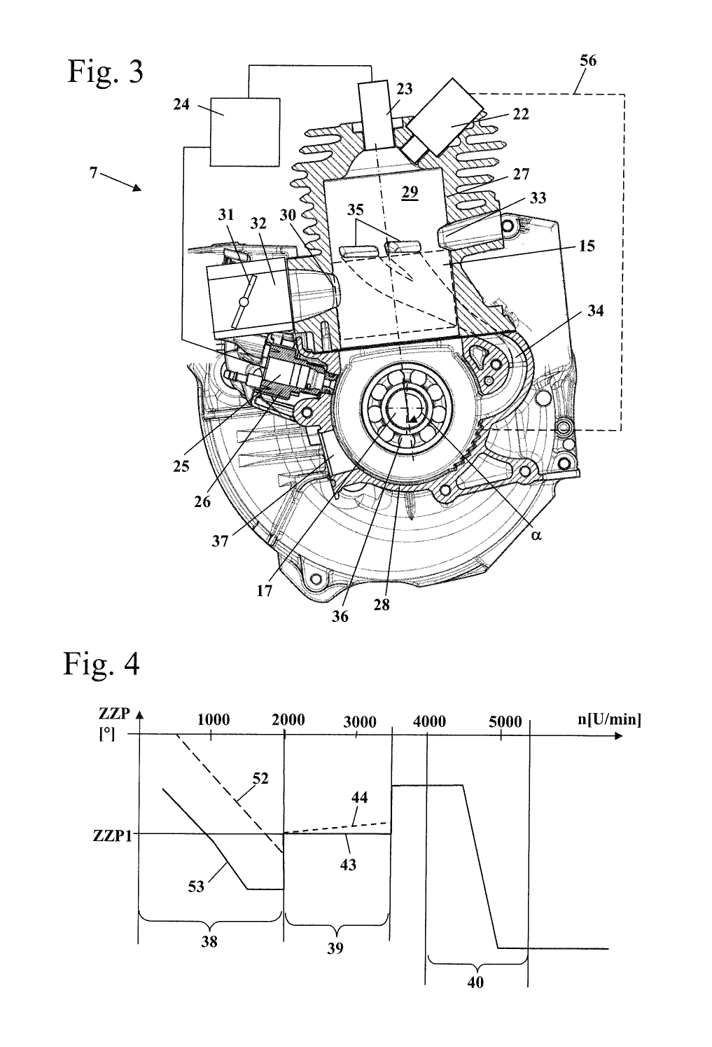

FIG. 3 shows the construction of the internal combustion engine 7 in detail. The internal combustion engine 7 has a cylinder 27, into which a decompression valve 22 and a spark plug 23 protrude. The actuation of the spark plug 23 takes place via a control device 24. The control device 24 also controls a fuel valve 25 which, in the embodiment, is arranged on a crankcase 28 of the internal combustion engine 7. The fuel valve 25 feeds fuel under low pressure into the interior of the crankcase 28. The interior of the crankcase 28 is connected via a crossflow channel 34 to a combustion chamber 29 which is formed in the cylinder 27. The crossflow channel 34 is divided into a plurality of branches, into four branches in the embodiment, which open via corresponding crossflow windows 35 into the combustion chamber 29. A different number or design of one or more crossflow channels 34 can also be advantageous.

The crossflow windows 35 are controlled by the piston 15 (shown diagrammatically in FIG. 3). An intake channel 32 with an inlet 30 into the crankcase 28, which inlet 30 is likewise controlled by the piston 15, opens at the cylinder bore. The intake channel 32 is connected to the interior of the crankcase 28 in the region of the top dead center of the piston 15. A throttle element 31 is configured as a pivotably mounted throttle valve and is arranged in the intake channel 32. An outlet 33 is likewise controlled by the piston 15 and is advantageously adjoined by an outlet (not shown) leading out of the combustion chamber 29.

As FIG. 3 shows, the fuel valve 25 is arranged in a valve holder 26 which is fixed on the crankcase 28. Moreover, a receptacle 37 for further components opens at the crankcase 28. For example, a structural unit comprising temperature sensor and pressure sensor can be arranged in the receptacle 37. The crankshaft 17 is mounted in the crankcase 28 by way of a bearing 36. The rotary position of the crankshaft 17 is described via a crankshaft angle α. The crankshaft angle α is 0° at the top dead center of the piston 15 and, in the position which is shown diagrammatically in FIG. 3, the crankshaft angle α is 180° in the bottom dead center of the piston 15.

During operation of the internal combustion engine 7, in the region of the top dead center of the piston 15, that is, at a crankshaft angle α of 0°, combustion air is drawn into the interior of the crankcase 28. Fuel is metered into the combustion air via the fuel valve 25. The fuel is atomized on account of the rotating parts in the crankcase interior and is prepared with the combustion air to produce an air/fuel mixture. The mixture in the interior of the crankcase 28 is compressed during the downward stroke of the piston 15, that is, during the movement of the piston 15 in the direction of the crankcase 28, and is pressed into the combustion chamber 29 as soon as the crossflow windows 35 are opened by the piston 15. During the subsequent upward stroke of the piston 15, that is, during the movement of the piston 15 in the direction of the combustion chamber 29, the air/fuel mixture in the combustion chamber 29 is compressed and is ignited by the spark plug 23 in the region of top dead center of the piston 15. During the subsequent downward stroke of the piston 15, the outlet 33 is opened, and the exhaust gases escape from the combustion chamber 29.

The ignition time point ZZP is controlled by the control device 24 in dependence on the rotational speed (n) of the internal combustion engine 7 according to the diagram shown in FIG. 4. Here, the ignition time point ZZP is specified as crankshaft angle α before the top dead center of the piston 15. The further to the bottom an ignition time point is shown in the diagram, the more advanced the ignition at this ignition time point takes place in relation to the top dead center of the piston 15. In a starting speed range 38, the ignition time point is controlled according to a line 52. As the rotational speed (n) increases, the ignition time point ZZP is adjusted in the direction of “advance” here. In the embodiment, the starting speed range 38 extends as far as approximately 2000 rpm. The starting speed range is adjoined by an idling speed range 39. The idling speed range 39 can advantageously lie in the rotational speed range from approximately 1500 rpm to approximately 4000 rpm. The idling speed range 39 lies below an engagement speed range 40 wherein the centrifugal clutch 20 begins to engage. The engagement speed range 40 can extend in the region of from approximately 3000 rpm to approximately 6000 rpm. In the embodiment, the idling speed range 39 extends from approximately 2000 rpm to approximately 3500 rpm and the engagement speed range extends from approximately 4000 rpm to approximately 5500 rpm.

In the idling speed range 39, the ignition time point ZZP is controlled using an idle control 43 which sets the ignition time point ZZP to a fixed, most advanced ignition time point ZZP1. However, it can also be provided that the ignition time point ZZP is controlled in the idling speed range 39 depending on the rotational speed (n). It is provided here, in particular, that the ignition time point ZZP is adjusted in the direction of “retard” as the rotational speed (n) increases, the adjustment taking place linearly, in particular. A corresponding idle control 44 is shown by way of a dashed line in FIG. 4.

The starting operation begins with the beginning of the pull-rope starter operation, that is, when an operator begins to pull the pull-rope handle 11, and ends with the first combustion in the combustion chamber 29. Until the first combustion, the ignition time point ZZP is controlled using the line 52. If the rotational speed (n) drops during operation from the idling speed range 39 into the starting speed range 38, that is, below 2000 rpm in the embodiment, the ignition time point ZZP is controlled in dependence on the line 53. It is provided here to adjust the ignition time point ZZP in the direction of “advance”. Here, the ignition time point ZZP, which is provided according to the line 53, can also lie ahead of the most advanced ignition time point ZZP1.

The decompression valve 22 serves to reduce the compression pressure during starting of the internal combustion engine 7, with the result that the operator has to apply less force to pull the pull-rope handle 11. The decompression valve 22 can be opened by hand by the operator before starting of the internal combustion engine 7. However, it can also be provided that the decompression valve 22 is set into the open position automatically, for example before or during the actuation of the pull-rope starter 10. As soon as a combustion takes place in the combustion chamber 29, the decompression valve 22 is to close on account of the combustion pressure.

FIG. 8 shows by way of example a possible construction of a decompression valve 22. The decompression valve 22 has a holder 55 which forms a housing and in which a closing element 46 is arranged. In the exemplary embodiment, the closing element 46 is of pin-shaped configuration and has a closing section 54 which, in the closed state of the decompression valve 22, interacts with a valve seat 45 which is formed on the holder 55. In the open position (shown in FIG. 8) of the decompression valve, air can escape from the combustion chamber 29 along the outer circumference of the closing element 46 through an opening 47 which is formed in the holder 55 into a pressure relief space, for example into the surroundings. If the air is to escape into the surroundings, the opening 47 is open to the outside. The pressure relief space can also be, for example, the interior of the crankcase 28. If the air is to escape into the interior of the crankcase 28, the decompression valve 22 can be connected to the interior of the crankcase 28 via a connecting line 56 (shown as a broken line in FIG. 3).

The closing element 46 is connected to an actuating button 49 which is to be pressed by the operator in order to open the decompression valve 22. Here, a spring 48 is compressed and latching balls 50 latch in a latching depression 51 of the closing element 46. A pressure face 57, on which the combustion pressure acts, is formed on the end side of the closing element 46. If the combustion pressure is sufficiently high, the force which acts on the pressure face 57 is sufficient to move the latching balls 50 out of the latching depression 51 and to deflect them counter to the force which is applied by a spring element 58 which resiliently biases the latching balls 50. This takes place with the assistance of the force of the spring 48.

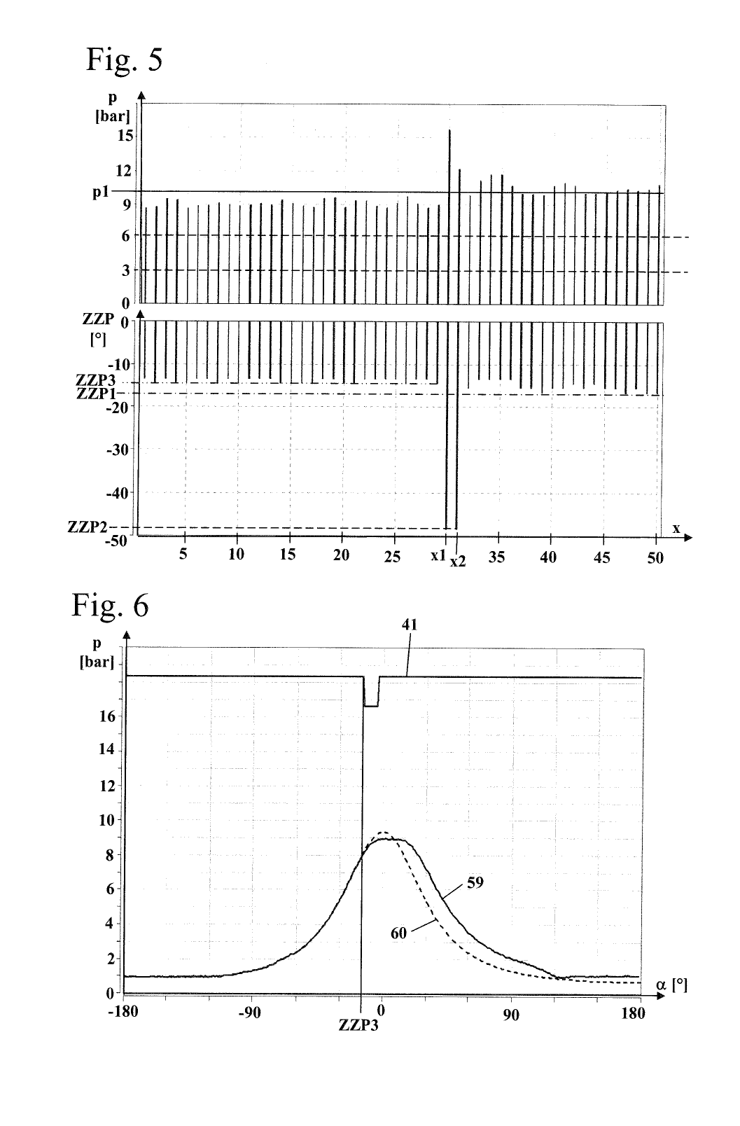

The decompression valve 22 has to be designed in such a way that the closing element 46 latches reliably in the open position, and that secure closing of the decompression valve 22 is ensured after starting of the internal combustion engine 7. Depending on the internal combustion engine 7, the combustion pressure in the combustion chamber 29 can be comparatively low after the starting operation. FIG. 5 shows this. FIG. 5 shows the first 50 engine cycles (x) after starting of the internal combustion engine 7, that is, from the first combustion in the combustion chamber 29. As FIG. 5 shows, the pressure (p) in the combustion chamber lies in the order of magnitude of approximately 9 bar for the first 28 engine cycles (x). In the embodiment, the closing pressure p1 of the decompression valve 22 lies somewhat higher, with the result that the decompression valve 22 remains open. Here, the ignition time point ZZP is controlled using the rotational speed (n), to be precise using the idle control 44 (FIG. 4). The fact that the ignition time point ZZP is controlled using the rotational speed (n) results from the fact that the ignition time point ZZP is not constant in the lower diagram in FIG. 5, but rather changes slightly from engine cycle to engine cycle. However, a constant ignition time point ZZP can also be provided, for example as is stipulated by way of the idle control 43.

At an engine cycle x1, which is the 30th engine cycle after starting in the embodiment, the ignition time point ZZP is adjusted in the “advance” direction from an ignition time point ZZP3 to a closing ignition time point ZZP2. The closing ignition time point ZZP2 advantageously lies at least approximately 5° crankshaft angle α, preferably at least approximately 10° crankshaft angle α, in particular 20° crankshaft angle α before the most advanced ignition time point ZZP1. Here, the closing ignition time point ZZP2 lies at most approximately 40° crankshaft angle before the most advanced ignition time point ZZP1. In the embodiment, the closing ignition time point ZZP2 lies by from 30° to 35° crankshaft angle, in particular approximately 33° crankshaft angle ahead of the ignition time point ZZP3.

As FIG. 5 shows in the upper part of the diagram, the pressure (p) in the combustion chamber 29 increases as a result to over 15 bar, that is, to a pressure considerably above the closing pressure p1 of the decompression valve 22. As a result, the decompression valve 22 is closed. The ignition also once again takes place at the closing ignition time point ZZP2 in the following engine cycle x2 which corresponds to the 31st engine cycle in the embodiment. Although the pressure (p), which is set in the combustion chamber 29, is lower than that in the engine cycle x1, it is considerably higher than the closing pressure p1 of the decompression valve. The decompression valve 22 is now closed. From the following engine cycle (x) which is the 32nd engine cycle in the embodiment, the ignition takes place again at an ignition time point ZZP which is determined using the idle control 44. As FIG. 5 also shows, the pressure (p) in the combustion chamber 29 is slightly higher after closing of the decompression valve 22 than before closing of the decompression valve 22, and usually lies above the closing pressure p1. Since a combustion does not have to take place in every engine cycle during idling, the ignition at the closing time point ZZP2 in more than one engine cycle can ensure that a combustion has taken place in at least one engine cycle, in which ignition was carried out at the closing ignition time point ZZP2.

The closing ignition time point ZZP2 can be a fixed value which is stored in the control device 24. However, it can also be provided that the ignition time point ZZP which is determined using the idle control 44 for this or a preceding engine cycle (x) is adjusted in the direction of “advance” by a predefined crankshaft angle α, for example by from approximately 30° to approximately 35° crankshaft angle α. Here, the control device 24 can interrupt the control of the ignition time point ZZP according to the idle control 44 for the at least one engine cycle (x1, x2), at which the closing time point ZZP2 is set. However, the control device 24 can also override the ignition time point ZZP, which is provided according to the idle control 44, by the ignition time point ZZP being triggered at the more advanced time point and sufficient energy for triggering an ignition spark no longer being available for the triggering of an ignition spark at the more retarded time point which is provided by the idle control 44.

It is provided in the embodiment according to FIG. 5 that the closing ignition time point ZZP2 is set for two engine cycles. Here, the two engine cycles take place during the first 100 engine cycles, in particular during the first 50 engine cycles after the starting operation.

FIG. 6 shows the pressure profile of the pressure p in the combustion chamber 29 during the engine cycle 29. A line 41 diagrammatically indicates the ignition time point. As FIG. 6 shows, the pressure (p), which is illustrated using a line 59, increases after the triggering of the ignition spark to approximately 9 bar. The ignition takes place at the ignition time point ZZP3 which lies at from approximately 10° to approximately 20°, in particular at approximately 15° before the top dead center of the piston 15. In FIG. 6, a compression curve 60 without ignition, what is known as an overrun curve, is shown with a dashed line.

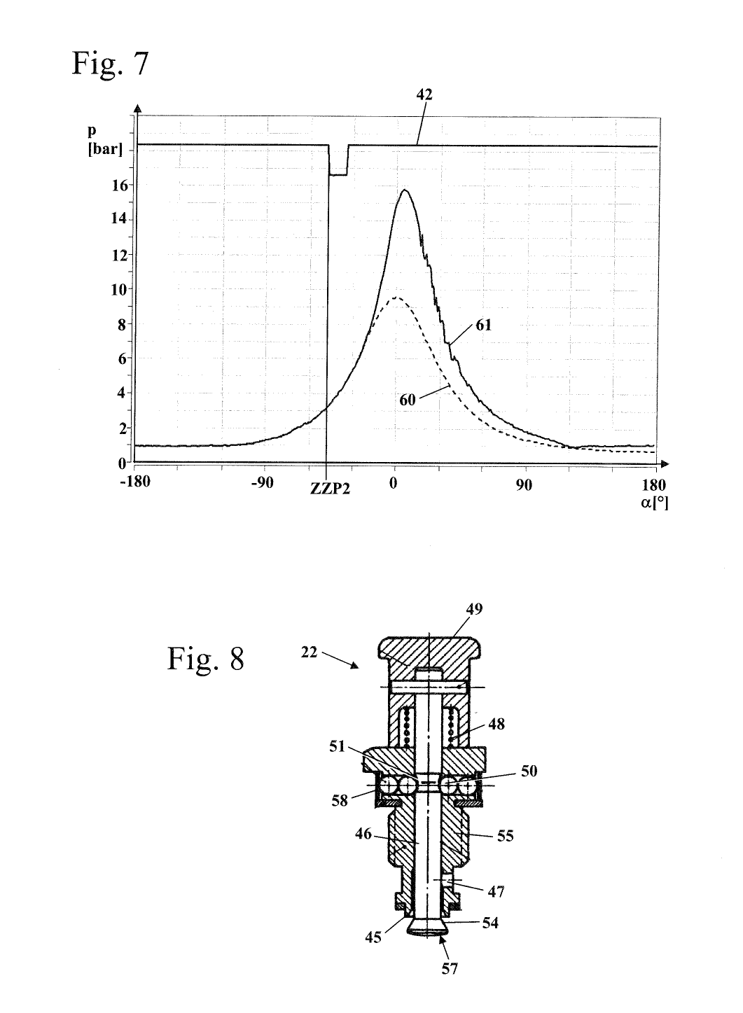

In FIG. 7, the pressure profile in the combustion chamber 29 during the engine cycle x1, which follows the 29th engine cycle, is illustrated by a line 61. The ignition time point ZZP which is shown diagrammatically by a line 42 lies at the closing ignition time point ZZP2. The closing ignition time point ZZP2 is considerably more advanced than the most advanced ignition time point ZZP1 according to the idle control 39 and, in the embodiment, lies at approximately 47° before the top dead center of the piston 15. On account of the very advanced ignition time point, a pronounced combustion takes place, and the pressure in the combustion chamber 29 increases to a value of over 15 bar. Since the pressure (p) lies considerably above the closing pressure p1 of the decompression valve 22, the decompression valve 22 is closed. The comparison curve 60 is also illustrated in FIG. 7.

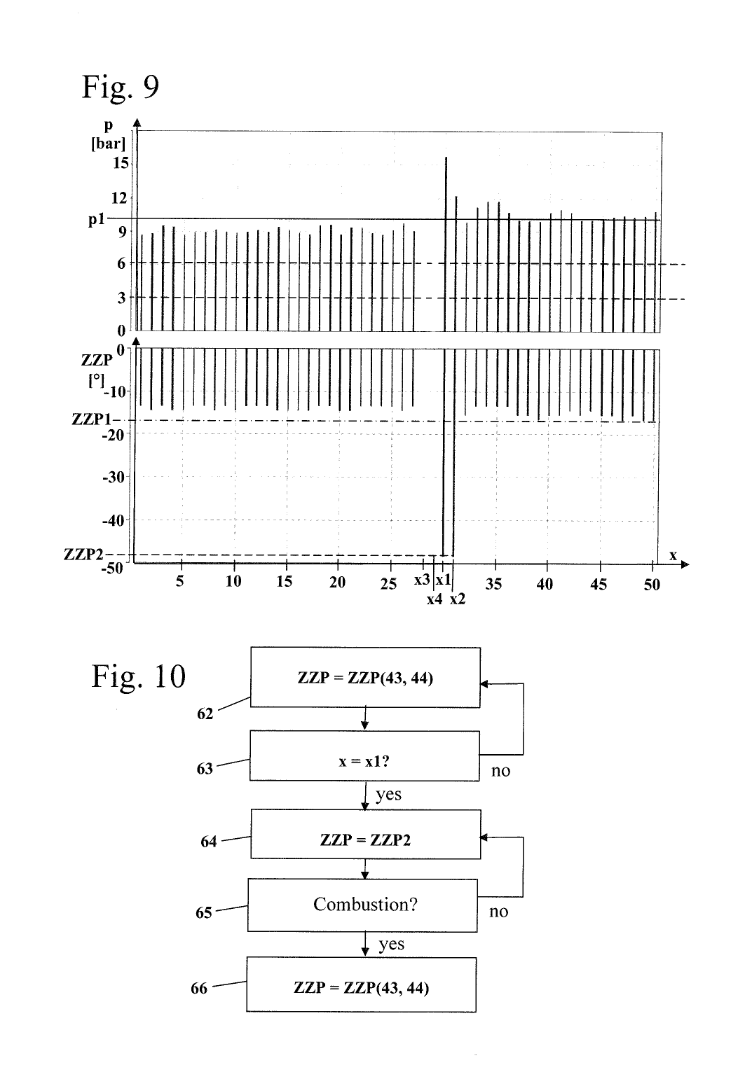

FIG. 9 shows one embodiment of the method, in which the ignition is interrupted in two engine cycles x3 and x4 before the engine cycles x1 and x2, in which the ignition is adjusted to the closing ignition time point ZZP2. This ensures that the combustion chamber 29 is flushed satisfactorily in the engine cycle x1 and there is a favorable mixture composition in the combustion chamber 29, with the result that a combustion can take place in the combustion chamber 29.

FIG. 10 shows a flow diagram of an alternative method for operating the internal combustion engine 7. The ignition time point ZZP is set in method step 62 using the idle control 43 or using the idle control 44. A check is made in method step 63 as to whether the engine cycle x1 has already been reached. If the engine cycle x1 has not yet been reached, the ignition time point ZZP is still controlled in method step 62 using the idle control 43 or 44. After the engine cycle x1 is reached, the ignition time point ZZP is adjusted to the closing ignition time point ZZP2. It is subsequently determined in method step 65 whether a combustion has taken place in the combustion chamber 29. This can take place, for example, by way of a determination of the acceleration of the crankshaft 17 using the rotational speed (n) of the crankshaft 17 or by way of a determination of the pressure (p) in the combustion chamber 29. If no combustion has taken place, the closing ignition time point ZZP2 is once again set as ignition time point ZZP and a check is made as to whether a combustion has now taken place. As soon as a combustion has taken place, the ignition time point ZZP is set again in method step 66 using the idle controls 43 or 44.

It is understood that the foregoing description is that of the preferred embodiments of the invention and that various changes and modifications may be made thereto without departing from the spirit and scope of the invention as defined in the appended claims.

What is claimed is:

1. A method for operating an internal combustion engine including:
a piston and a cylinder having a combustion chamber delimited by said piston;
said piston being journalled so as to carry out a reciprocating back and forth movement in said cylinder;
a crankcase and a crankshaft rotatably mounted in said crankcase and driven by said piston;
a spark plug projecting into said combustion chamber;
a starter device for starting said engine;
a control unit for controlling the ignition time point (ZZP) of the ignition of said spark plug;
a decompression valve defining a closed state and an open state wherein said decompression valve connects said combustion chamber to a pressure relief space;
said decompression valve being configured to be in said open state when said engine is started and in said closed state when a pressure (p) in said combustion chamber exceeds a predetermined closing pressure (p1);
said method comprising the steps of:
controlling said ignition time point (ZZP) in an idle speed range in accordance with an idle control having a most advanced ignition time point (ZZP1); and,
causing the ignition to occur at a closing ignition time point (ZZP2) in said idle speed range for at least one engine cycle (x1, x2) departing from said idle control with said closing ignition time point (ZZP2) lying at least approximately at 5° crankshaft angle (α) ahead of said most advanced ignition time point (ZZP1) to bring said decompression valve into said closed state thereof.

2. The method of claim 1, wherein said closing ignition time point (ZZP2) lies at most approximately at 40° crankshaft angle (α) ahead of said most advanced ignition time point (ZZP1).

3. The method of claim 1, wherein said closing ignition time point (ZZP2) lies at least approximately at 20° crankshaft angle (α) ahead of said most advanced ignition time point (ZZP1).

4. The method of claim 1, wherein said ignition time point (ZZP) is determined based on said idle control at 0° to approximately 20° crankshaft angle (α) ahead of top dead center.

5. The method of claim 1, wherein said closing ignition time point (ZZP2) lies at approximately 25° to approximately 50° crankshaft angle (α) ahead of top dead center.

6. The method of claim 1, wherein said at least one engine cycle (x1, x2), wherein said ignition occurs at said closing ignition time point (ZZP2), takes place during the first 100 engine cycles (x) after the start operation.

7. The method of claim 1, wherein said at least one engine cycle (x1, x2), wherein said ignition occurs at said closing ignition time point (ZZP2), takes place during the first 50 engine cycles (x) after the start operation.

8. The method of claim 1, wherein said at least one engine cycle (x1, x2) wherein the ignition occurs at said closing ignition time point (ZZP2) precedes at least one engine cycle (x3, x4) wherein no ignition occurs.

9. The method of claim 1, further comprising the step of determining whether a combustion has taken place in said combustion chamber after an engine cycle (x1) wherein an ignition has occurred at said closing ignition time point (ZZP2) and, if no combustion is detected, causing the ignition to take place anew in the next engine cycle (x2) at said closing ignition time point (ZZP2).

10. The method of claim 1, wherein said closing ignition time point (ZZP2) is a fixed ignition time point (ZZP) stored in said control unit.

11. The method of claim 1, further comprising the step of determining said closing ignition time point (ZZP2) based on an ignition time point (ZZP) provided in accordance with said idle control.

12. The method of claim 1, wherein said idle control controls the ignition time point (ZZP) in dependence upon the rotational speed (n) of said internal combustion engine.

13. The method of claim 1, wherein said idle control fixes said ignition time point (ZZP) to a constant ignition time point.

14. The method of claim 1, wherein said pressure relief space is the ambient or the interior space of said crankcase.
